(19) United States
(12) Patent Application Publication
(10) Pub. No.: US 2025/0138405 A1
(43) Pub. Date: May 1, 2025

(54) WAVELENGTH CONVERTER, METHOD FOR MANUFACTURING WAVELENGTH CONVERTER, LIGHT SOURCE APPARATUS, AND PROJECTOR

(71) Applicant: SEIKO EPSON CORPORATION, Tokyo (JP)

(72) Inventor: Hideo MIYASAKA, OKAYA-SHI (JP)

(21) Appl. No.: 18/926,593

(22) Filed: Oct. 25, 2024

(30) Foreign Application Priority Data
Oct. 26, 2023 (JP) 2023-183838

(51) Int. Cl. G03B 21/20

(52) U.S. Cl. CPC G03B 21/204

(57) ABSTRACT

A wavelength converter according to an aspect of the present disclosure includes a wavelength converting layer having a first surface on which light is incident and a second surface opposite from the first surface and configured to convert the incident light, a substrate disposed at a side facing the second surface of the wavelength converting layer, and a bonding layer configured to bond the substrate and the wavelength converting layer to each other, the bonding layer includes a first layer facing the substrate and a second layer disposed between the first layer and the wavelength converting layer, and a porosity of the first layer is higher than a porosity of the second layer.

The present application is based on, and claims priority from JP Application Serial Number 2023-183838, filed Oct. 26, 2023, the disclosure of which is hereby incorporated by reference herein in its entirety.

### BACKGROUND

### 1. Technical Field

The present disclosure relates to a wavelength converter, a method for manufacturing the wavelength converter, a light source apparatus, and a projector.

### 2. Related Art

In recent years, there is an illuminator using fluorescence as illumination light. For example, JP-A-2011-129354 discloses an illuminator including a light source that outputs laser light and a wavelength converter that emits fluorescence in response to incidence of the laser light. In the illuminator, the wavelength converter includes a phosphor layer, a heat dissipating substrate provided at the side of the phosphor layer that is opposite from the side on which excitation light is incident, and a bonding layer that bonds the phosphor layer and the heat dissipating substrate to each other.

JP-A-2011-129354 is an example of the related art.

In the illuminator described above, since the phosphor layer and the heat dissipating substrate have expansion coefficients different from each other, heat generated by the phosphor layer may cause the phosphor layer to peel off the heat dissipating substrate or breakage of the phosphor layer due to thermal stress induced by the difference in coefficient of thermal expansion. It is conceivable to improve the strength of the bonding between the phosphor layer and the heat dissipating substrate by providing a bonding layer having voids provided therein to reduce the thermal stress, but the voids reduce the thermal conductivity of the bonding layer, resulting in another problem of a decrease in efficiency at which the phosphor layer is cooled.

### SUMMARY

To solve the problems described above, according to a first aspect of the present disclosure, there is provided a wavelength converter including: a wavelength converting layer having a first surface on which light is incident and a second surface opposite from the first surface and configured to convert the incident light; a substrate disposed at a side facing the second surface of the wavelength converting layer; and a bonding layer configured to bond the substrate and the wavelength converting layer to each other, wherein the bonding layer includes a first metal layer facing the substrate and a second metal layer disposed between the first metal layer and the wavelength converting layer, and a porosity of the first metal layer is higher than a porosity of the second metal layer.

According to a second aspect of the present disclosure, there is provided a light source apparatus including: the wavelength converter according to the first aspect described above; and a light emitter configured to output the light to the wavelength converter.

According to a third aspect of the present disclosure, there is provided a projector including: the light source apparatus according to the second aspect described above; a light modulator configured to modulate light output from the light source apparatus based on image information, and a projection optical apparatus configured to project light output from the light modulator.

According to a fourth aspect of the present disclosure, there is provided a method for manufacturing a wavelength converter including a wavelength converting layer, a substrate, and a bonding layer configured to bond the substrate and the wavelength converting layer to each other, the bonding layer including a first metal layer facing the substrate and a second metal layer having a porosity higher than a porosity of the first metal layer and disposed between metal layer and the wavelength converting layer, the method including: a first step of disposing a first metal material at the substrate; a second step of disposing a second metal material having a particle size smaller than a particle size of the first metal material at the wavelength converting layer; and a third step of sintering the first metal material to form the first metal layer and sintering the second metal material to form the second metal layer to form the bonding layer.

According to a fifth aspect of the present disclosure, there is provided a method for manufacturing a wavelength converter including a wavelength converting layer, a substrate, and a bonding layer configured to bond the substrate and the wavelength converting layer to each other, the bonding layer including a first metal layer facing the substrate and a second metal layer having a porosity higher than a porosity of the first metal layer and disposed between the first metal layer and the wavelength converting layer, the method including: a first step of disposing a first metal material at the substrate; a second step of disposing a second metal material at the wavelength converting layer; and a third step of sintering the first metal material to form the first metal layer and sintering the second metal material at a sintering temperature higher than a temperature at which the first metal material is sintered to form the second metal layer to form the bonding layer.

### BRIEF DESCRIPTION OF THE DRAWINGS

FIG. 1 shows a schematic configuration of a projector according to a first embodiment.

FIG. 2 shows a schematic configuration of an illuminator.

FIG. 3 is a cross-sectional view showing the configurations of key parts of a wavelength converter.

FIG. 4 is an image showing the configurations of key parts of a bonding layer.

FIG. 5A shows a part of the step of manufacturing the wavelength converter.

FIG. 5B shows another part of the step of manufacturing the wavelength converter.

FIG. 5C shows another part of the step of manufacturing the wavelength converter.

FIG. 6 is a cross-sectional view showing the configurations of key parts of a wavelength converter according to a second embodiment.

FIG. 7 is a cross-sectional view showing the configurations of key parts of a wavelength converter according to a third embodiment.

### DESCRIPTION OF EMBODIMENTS

Embodiments of the present disclosure will be described below in detail with reference to the drawings.

In the drawings used in the description below, a characteristic portion is enlarged for convenience in some cases for clarity of the characteristic thereof, and the dimension ratio and other factors of each element are therefore not always equal to actual values.

### First Embodiment

An example of a projector according to the present embodiment will first be described.

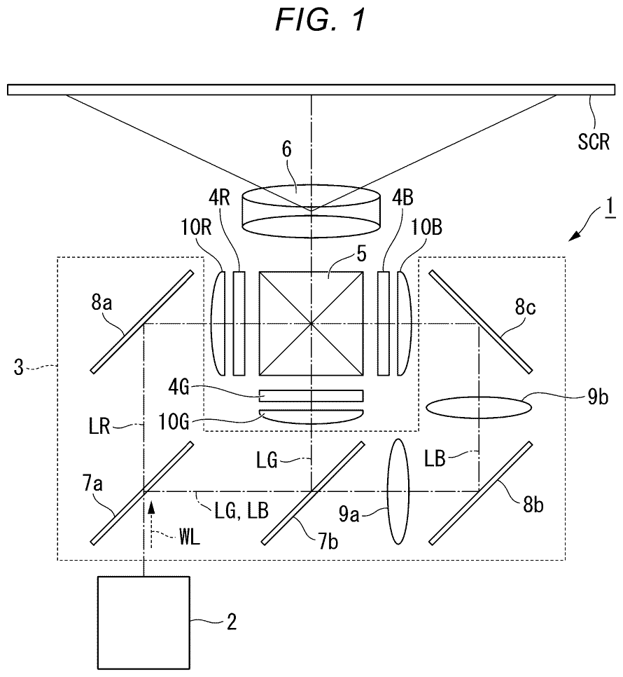

FIG. 1 shows a schematic configuration of the projector according to the present embodiment.

A projector 1 according to the present embodiment is a projection-type image display apparatus that displays color video images on a screen SCR, as shown in FIG. 1. The projector 1 includes an illuminator 2, a color separation system 3, light modulators 4R, 4G, and 4B, a light combining system 5, and a projection system 6.

The color separation system 3 separates illumination light WL into red light LR, green light LG, and blue light LB. The color separation system 3 generally includes a first dichroic mirror 7a, a second dichroic mirror 7b, a first reflection mirror 8a, a second reflection mirror 8b, a third reflection mirror 8c, a first relay lens 9a, and a second relay lens 9b.

The first dichroic mirror 7a separates the illumination light WL from the illuminator 2 into the red light LR and the other light (green light LG and blue light LB). The first dichroic mirror 7a transmits the separated red light LR and reflects the other light (green light LG and blue light LB). The second dichroic mirror 7b reflects the green light LG and transmits the blue light LB to separate the other light into the green light LG and the blue light LB.

The first reflection mirror 8a is disposed in the optical path of the red light LR and reflects the red light LR having passed through the first dichroic mirror 7a toward the light modulator 4R. The second reflection mirror 8b and the third reflection mirror 8c are disposed in the optical path of the blue light LB and guide the blue light LB having passed through the second dichroic mirror 7b to the light modulator 4B. The green light LG is reflected off the second dichroic mirror 7b toward the light modulator 4G.

The first relay lens 9a and the second relay lens 9b are disposed in the optical path of the blue light LB at positions downstream from the second dichroic mirror 7b.

The light modulator 4R modulates the red light LR in accordance with image information to form image light corresponding to the red light LR. The light modulator 4G modulates the green light LG in accordance with image information to form image light corresponding to the green light LG. The light modulator 4B modulates the blue light LB in accordance with image information to form image light corresponding to the blue light LB.

The light modulators 4R, 4G, and 4B are each, for example, a transmissive liquid crystal panel. Polarizers (not shown) are disposed at the light incident side and the light exiting side of each of the liquid crystal panels.

Field lenses 10R, 10G, and 10B are disposed at the light incident side of the light modulators 4R, 4G, and 4B, respectively. The field lenses 10R, 10G, and 10B parallelize the red light LR, the green light LG, and the blue light LB to be incident on the light modulators 4R, 4G, and 4B, respectively.

The image light from the light modulator 4R, the image light from the light modulator 4G, and the image light from the light modulator 4B enter the light combining system 5. The light combining system 5 combines the image light corresponding to the red light LR, the image light corresponding to the green light LG, and the image light corresponding to the blue light LB with one another and outputs the combined image light toward the projection system 6. The light combining system 5 is, for example, a cross dichroic prism.

The projection system 6 is configured with a projection lens group, enlarges the combined image light from the light combining system 5, and projects the enlarged image light toward the screen SCR. Enlarged color video images are thus displayed on the screen SCR.

### Illuminator

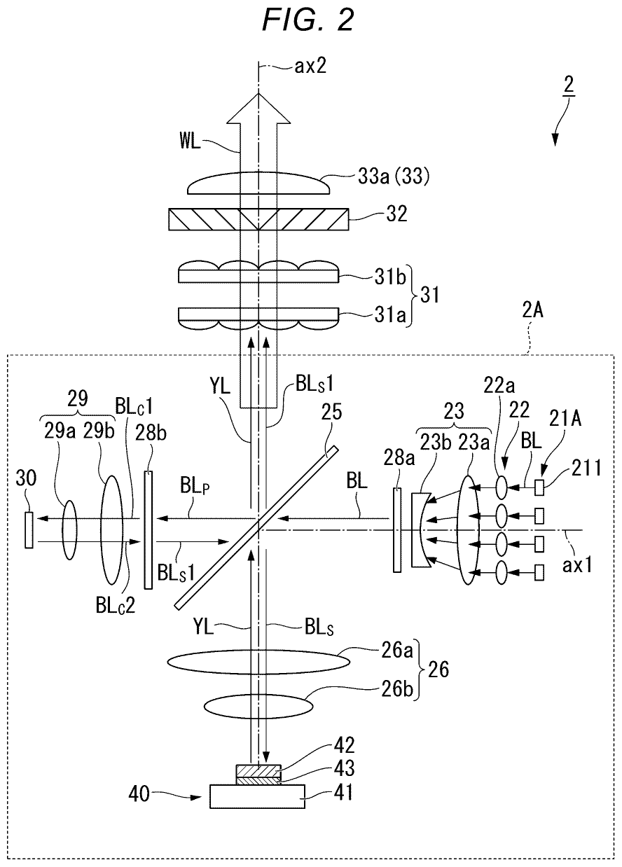

The illuminator 2 according to the present embodiment will subsequently be described. FIG. 2 shows a schematic configuration of the illuminator 2. The illuminator 2 includes a light source apparatus 2A, an optical integration system 31, a polarization converter 32, and a superimposing lens 33a, as shown in FIG. 2. In the present embodiment, the optical integration system 31 and the superimposing lens 33a constitute a superimposing system 33.

The light source apparatus 2A includes an array light source 21A, a collimator system 22, an afocal system 23, a first phase retarder 28a, a polarization separator 25, a first light collecting system 26, a wavelength converter 40, a second phase retarder 28b, a second light collecting system 29, and a diffusive reflector 30.

The array light source 21A, the collimator system 22, the afocal system 23, the first phase retarder 28a, the polarization separator 25, the second phase retarder 28b, the second light collecting system 29, and the diffusive reflector 30 are sequentially arranged in an optical axis ax1. The wavelength converter 40, the first light collecting system 26, the polarization separator 25, the optical integration system 31, the polarization converter 32, and the superimposing lens 33a are sequentially arranged in an illumination optical axis ax2. The optical axis ax1 and the illumination optical axis ax2 are present in the same plane and perpendicular to each other.

The array light source 21A includes multiple semiconductor lasers 211 as a solid-state light source. The multiple semiconductor lasers 211 are arranged in an array in a plane perpendicular to the optical axis ax1. The semiconductor lasers 211 each output, for example, a blue beam BL (laser light having peak wavelength of 460 nm, for example). The array light source 21A outputs a beam flux configured with the multiple beams BL. In the present embodiment, the array light source 21A corresponds to the “light source” in the claims.

The beams BL output from the array light source 21A enter the collimator system 22. The collimator system 22 converts each of the beams BL output from the array light source 21A into parallelized light. The collimator system 22 is configured, for example, with multiple collimator lenses 22a arranged in an array. The multiple collimator lenses 22a are disposed in correspondence with the multiple semiconductor lasers 211.

The beams BL having passed through the collimator system 22 enter the afocal system 23. The afocal system 23 adjusts the diameter of the luminous flux of the beams BL. The afocal system 23 is configured, for example, with a convex lens 23a and a concave lens 23b.

The beams BL having passed through the afocal system 23 enters the first phase retarder 28a. The first phase retarder 28a is, for example, a rotatable half-wave plate. The beams BL output from the semiconductor lasers 211 are each linearly polarized light. Appropriately setting the angle of rotation of the first phase retarder 28a allows the beams BL passing through the first phase retarder 28a to be beams each containing an S-polarized component and a P-polarized component mixed with each other at a predetermined ratio, the two components polarized with respect to the polarization separator 25. Rotating the first phase retarder 28a can change the ratio between the S-polarized component and the P-polarized component.

The beams BL generated when passing through the first phase retarder 28a and therefore containing the S-polarized component and the P-polarized component are incident on the polarization separator 25. The polarization separator 25 is configured, for example, with a polarizing beam splitter having wavelength selectivity. The polarization separator 25 inclines by an angle of 45° with respect to the optical axis ax1 and the illumination optical axis ax2.

The polarization separator 25 has a polarization separation function of separating each of the beams BL into an S-polarized beam BLs and a P-polarized beam BLp with respect to the polarization separator 25. Specifically, the polarization separator 25 reflects the S-polarized beam BLs and transmits the P-polarized beam BLp.

The polarization separator 25 further has a color separation function of transmitting fluorescence YL, which belongs to a wavelength band different from that of the beams BL, irrespective of the polarization state of the fluorescence YL.

The S-polarized beam BLs output from the polarization separator 25 enters the first light collecting system 26. The first light collecting system 26 collects the beams BLs toward the wavelength converter 40.

In the present embodiment, the first light collecting system 26 is configured, for example, with a first lens 26a and a second lens 26b. The beams BLs output from the first light collecting system 26 are incident on the wavelength converter 40 with the beams BLs collected at the wavelength converter 40.

The fluorescence YL generated by the wavelength converter 40 is parallelized by the first light collecting system 26 and is then incident on the polarization separator 25. The fluorescence YL passes through the polarization separator 25.

The P-polarized beam BLp output from the polarization separator 25 enters the second phase retarder 28b. The second phase retarder 28b is configured with a quarter-wave plate disposed in the optical path between the polarization separator 25 and the diffusive reflector 30. The P-polarized beams BLp output from the polarization separator 25 are therefore converted by the second phase retarder 28b, for example, into clockwise circularly polarized blue light BLc1, which then enters the second light collecting system 29.

The second light collecting system 29 is configured, for example, with convex lenses 29a and 29b, and causes the blue light BLc1 to be incident on the diffusive reflector 30 with the blue light BLc1 collected at the diffusive reflector 30.

The diffusive reflector 30 is disposed on the side of the polarization separator 25 opposite from a phosphor layer 42, and diffusively reflects the blue light BLc1 output from the second light collecting system 29 toward the polarization separator 25. The diffusive reflector 30 preferably reflects the blue light BLc1 in the Lambert reflection scheme but does not disturb the polarization state thereof.

The light diffusively reflected off the diffusive reflector 30 is hereinafter referred to as blue light BLc2. According to the present embodiment, diffusely reflecting the blue light BLc1 produces the blue light BLc2 having a substantially uniform illuminance distribution. For example, the clockwise circularly polarized blue light BLc1 is reflected in the form of counterclockwise circularly polarized blue light BLc2.

The blue light BLc2 is converted by the second light collecting system 29 into parallelized light, which then enters the second phase retarder 28b again.

The left-handed circularly polarized blue light BLc2 is converted by the second phase retarder 28b into S-polarization blue light BLs1. The S-polarized blue light BLs1 is reflected off the polarization separator 25 toward the optical integration system 31.

The blue light BLs1 is used as the illumination light WL along with the fluorescence YL having passed through the polarization separator 25. That is, the blue light BLs1 and the fluorescence YL are output from the polarization separator 25 in the same direction to produce the white illumination light WL, which is the mixture of the blue light BLs1 and the fluorescence (yellow light) YL.

The illumination light WL is output toward the optical integration system 31. The optical integration system 31 is configured, for example, with lens arrays 31a and 31b. The lens arrays 31a and 31b are each configured with multiple lenslets arranged in an array.

The illumination light WL having passed through the optical integration system 31 enters the polarization converter 32. The polarization converter 32 is configured with polarization separating films and phase retarders. The polarization converter 32 converts the illumination light WL containing the non-polarized fluorescence YL into linearly polarized light.

The illumination light WL having passed through the polarization converter 32 enters the superimposing lens 33a. The superimposing lens 33a in cooperation with the optical integration system 31 homogenizes the illuminance distribution of illumination the light WL in an illumination receiving region. The illuminator 2 thus produces the illumination light WL.

### Wavelength Converter

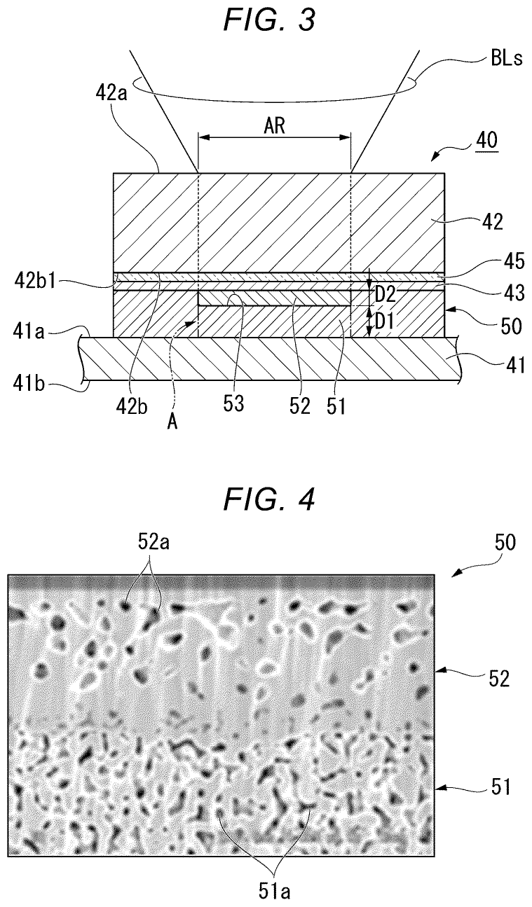

FIG. 3 is a cross-sectional view showing the configurations of key parts of the wavelength converter 40. The beams BLs output from the first light collecting system 26 and entering the phosphor layer 42 are hereinafter referred to as excitation light BLs.

The wavelength converter 40 includes a substrate 41, the phosphor layer 42, and a bonding layer 50, as shown in FIG. 3. The wavelength converter 40 according to the present embodiment has an immobile configuration in which the substrate 41 does not rotate. The substrate 41 has a front surface 41a facing the first light collecting system 26 and a rear surface 41b opposite from the front surface 41a. The bonding layer 50 bonds the substrate 41 and the phosphor layer 42 to each other. The wavelength converter 40 according to the present embodiment further includes a reflection member 43 provided between the bonding layer 50 and the phosphor layer 42. In the present embodiment, the phosphor layer 42 corresponds to the “wavelength converting layer” described in the claims.

The state in which the wavelength converter 40 is viewed along the direction in which the excitation light BLs is incident on the phosphor layer 42, that is, the direction of a normal to a first surface 42a, which is the direction in which the chief ray of the excitation light BLs is incident on the phosphor layer 42, is hereinafter referred to as “in the plan view” in some cases.

The substrate 41 is preferably made of a material that has high thermal conductivity and excels in heat dissipation, and examples of the material may include metal such as aluminum and copper, and ceramic such as aluminum nitride, alumina, sapphire, and diamond. In the present embodiment, the substrate 41 is made of copper.

The rear surface 41b of the substrate 41 may be provided with a heat dissipation member configured with a heat sink to further enhance the heat dissipation capability of the substrate 41 to suppress thermal degradation of the phosphor layer 42.

In the present embodiment, the phosphor layer 42 is a ceramic phosphor formed by sintering phosphor particles. A YAG (yttrium aluminum garnet) phosphor containing Ce ions is used as the phosphor particles that constitute the phosphor layer 42.

The phosphor particles may be made of one kind of material or may be a mixture of particles made of two or more kinds of materials. The phosphor 42 is preferably, for example, a phosphor layer in which the phosphor particles are dispersed in an inorganic binder such as alumina, a phosphor layer formed by sintering a glass binder, which is an inorganic material, and the phosphor particles. The phosphor layer may instead be formed by sintering the phosphor particles without using a binder.

The phosphor layer 42 is held above the front surface 41a of the substrate 41 via the bonding layer 50, which will be described later. The phosphor layer 42 has the first surface 42a, on which the excitation light BLs is incident and via which the fluorescence YL, into which the excitation light BLs is converted in terms of wavelength, exits, and a surface opposite from the first surface 42a, that is, a second surface 42b, at which the reflection member 43 and the substrate 41 are provided. That is, in the present embodiment, the substrate 41 is disposed on the side of the phosphor layer 42 that is opposite from the first surface 42a, on which the excitation light BLs is incident. The reflection member 43 reflects the light incident from the phosphor layer 42 toward the first light collecting system 26.

The phosphor layer 42 has multiple pores provided therein and therefore has light scattering characteristics. Since some of the multiple pores are formed at the second surface 42b of the phosphor layer 42, the second surface 42b of the phosphor layer 42 has unevenness due to the pores. The phosphor layer 42 in the present embodiment includes a planarizing film 45, which planarizes the second surface 42b. The planarizing film 45 is made of a light transmissive inorganic material, for example, SiO₂. The planarizing film 45 fills the unevenness of the second surface 42b to planarize the second surface 42b.

The reflection member 43 in the present embodiment is configured by layering a total reflection layer configured with a multilayer film and a reflection layer made of a metal material having high reflectance such as Ag with one of the two layers layered on the other. The reflection member 43 is formed by sequentially forming the multilayer film and the reflection layer on the planarizing film 45, for example, in a vapor deposition or sputtering process.

In the present embodiment, the planarizing film 45 is made, for example, of the same material (SiO₂) as the surface layer of the total reflection layer, which is configured with the multilayer film and located at the side of the reflection member 43 that faces the phosphor layer 42. The adhesion between the planarizing film 45 and the reflection member 43 is thus improved.

Furthermore, since the planarizing film 45 makes the surface of the phosphor layer 42 substantially planar, as described above, the multilayer film and the reflection layer that constitute the reflection member 43 can be uniformly formed at the second surface 42b of the phosphor layer 42. In addition, since the adhesion between the second surface 42b of the phosphor layer 42 and the bonding layer 50 is enhanced, the bonding strength produced by the bonding layer 50 can be further improved.

The reflection member 43 can thus reflect part of the fluorescence YL generated in the phosphor layer 42 and traveling toward the substrate 41 toward the first surface 42a to efficiently extract the fluorescence YL out of the phosphor layer 42.

The bonding layer 50 includes a first metal layer 51 and a second metal layer 52. The first metal layer 51 is a metal layer facing the substrate 41. The second metal layer 52 is a metal layer disposed between the first metal layer 51 and the phosphor layer 42.

The bonding layer 50 is sized so as to cover the entire second surface 42b of the phosphor layer 42. In the present embodiment, the outer circumferential side of the bonding layer 50 coincides with the outer circumferential side of the phosphor layer 42 in the plan view. The bonding layer 50 is therefore bonded to a circumferential edge 42b1 of the second surface 42b of the phosphor layer 42.

Consider now a case where the size of the bonding layer 50 is slightly smaller than the size of the second surface 42b of the phosphor layer 42 and the circumferential edge 42b1 of the second surface 42b is exposed beyond the bonding layer 50. The situation in which the circumferential edge 42b1 of the second surface 42b is exposed beyond the bonding layer 50 causes a problem of a tendency to cause the bonding layer 50 to peel off the circumferential edge 42b1 of the second surface 42b. In addition, an external force acting on the circumferential edge 42b1 of the second surface 42b for some reason could cause failure such as chipping or cracking of the circumferential edge 42b1.

In contrast, the bonding layer 50 in the present embodiment is bonded to the circumferential edge 42b1 of the second surface 42b of the phosphor layer 42 as described above and therefore the failure such as peeling of the bonding layer 50 chipping or cracking of the circumferential edge 42b1 can be suppressed. The bonding layer 50 in the present embodiment can therefore further enhance the reliability of the bonding between the substrate 41 and the phosphor layer 42.

The first metal layer 51 is provided at the front surface 41a of the substrate 41. The second metal layer 52 is disposed in a recess 53 provided in the first metal layer 51 and is in contact with the second surface 42b of the phosphor layer 42. The first metal layer 51 is in contact with the second surface 42b of the phosphor layer 42 across the region excluding the recess 53. That is, the first metal layer 51 and the second metal layer 52 are in contact with the second surface 42b of the phosphor layer 42.

The first metal layer 51 is formed by sintering a first metal material containing at least one of Ag, Au, and Cu. The second metal layer 52 is formed by sintering a second metal material containing at least one of Ag, Au, and Cu. That is, the first metal layer 51 contains at least one of Ag, Au, and Cu, and the second metal layer 52 contains at least one of Ag, Au, and Cu.

FIG. 4 is an image showing the configurations of key parts of the bonding layer 50.

The first metal layer 51 has multiple pores 51a, and the second metal layer 52 has multiple pores 52a, as shown in FIG. 4. The ratio of voids produced by the pores 51a to the entire volume of the first metal layer 51 is referred to as the “porosity of the first metal layer 51”, and the ratio of voids produced by the pores 52a to the entire volume of the second metal layer 52 is referred to as the “porosity of the second metal layer 52”.

In the bonding layer 50 in the present embodiment, the porosity of the first metal layer 51 is higher than the porosity of the second metal layer 52. It is preferable that the porosity of the first metal layer 51 is higher than or equal to 30% but lower than 40%, and that the porosity of the second metal layer 52 is higher than or equal to 10% but lower than 30%.

The first metal layer 51 has a porosity higher than that of the second metal layer 52, and thus has a relatively small Young's modulus and deforms by a relatively large amount. Therefore, in the bonding layer 50, the first metal layer 51 can function as a stress relaxation layer that relaxes thermal stress induced by the difference in coefficient of thermal expansion between the substrate 41 and the phosphor layer 42. The first metal layer 51 of the bonding layer 50 can therefore suppress occurrence of failure such as peeling or breakage of the phosphor layer 42 due to the thermal stress.

In the present embodiment, the second metal layer 52 is disposed in the recess 53 of the first metal layer 51. The first metal layer 51 is therefore disposed so as to surround the circumference of the second metal layer 52. In the present embodiment, the first metal layer 51 surrounds the entire circumference of the second metal layer 52 in the plan view of the bonding layer 50. Note that the first metal layer 51 in the plan view may have any of a rectangular shape, a circular shape, and an elliptical shape.

According to the configuration described above, since the first metal layer 51 is disposed so as to surround the circumference of the second metal layer 52 within the bonding surface of the bonding layer 50, the first metal layer 51 can provide the stress relaxation function in a balanced manner within the bonding surface. The effect of suppressing peeling or breakage of the phosphor layer 42 can therefore be further enhanced.

Since the porosity of the second metal layer 52 is lower than that of the first metal layer 51, the thermal conductivity of the second metal layer 52 is relatively higher than that of the first metal layer 51, so that the heat dissipation capability of the phosphor layer 42 can be increased.

In the present embodiment, the second metal layer 52 is disposed in correspondence with a light incident region AR of the phosphor layer 42, which is the region on which the excitation light BLs is incident. That is, the second metal layer 52 is disposed in a region where the second metal layer 52 overlaps with at least a part of the light incidence region AR when the first surface 42a of the phosphor layer 42 is viewed along a normal thereto. In the present embodiment, the second metal layer 52 is disposed in a region where the second metal layer 52 overlaps with the entire light incident region AR.

Although the phosphor layer 42 generates heat when generating the fluorescence YL, the light incident region AR usually has the highest temperature. According to the bonding layer 50 in the present embodiment, the second metal layer 52 having high thermal conductivity and disposed in the region corresponding to the highest-temperature light incident region AR of the phosphor layer 42 can efficiently dissipate the heat of the phosphor layer 42.

The second metal layer 52 has a Young's modulus greater than that of the first metal layer 51 and is therefore less likely to deform. The bonding strength of the bonding layer 50 can therefore be improved through bonding the substrate 41 and the phosphor layer 42 to each other via the first metal layer 51.

In the bonding layer 50 in the present embodiment, since the first metal layer 51 and the second metal layer 52 are in contact with the second surface 42b of the phosphor layer 42, the stress relaxation function of the first metal layer 51 and the cooling efficiency improvement function of the second metal layer 52 can be efficiently provided within the bonding surface.

A first region A is now defined as a region where the first metal layer 51 and the second metal layer 52 in the bonding layer 50 overlap with each other in the direction in which the excitation light BLs is incident on the phosphor layer 42. That is, the bonding layer 50 in the present embodiment has the first region A, where the first metal layer 51 and the second metal layer 52 overlap with each other in the direction in which the excitation light BLs is incident on the phosphor layer 42.

The second metal layer 52 has a lower porosity and a denser structure than those of the first metal layer 51, and the volume of the second metal layer 52 therefore shrinks when the material thereof is sintered at a rate higher than the rate at which the first metal layer 51 shrinks, so that too large a thickness of the second metal layer 52 may cause cracking thereof. On the other hand, the stress relaxation function of the first metal layer 51 increases in proportion to the thickness thereof.

In the bonding layer 50 in the present embodiment, a thickness D1 of the first metal layer 51 along the light incident direction is greater than a thickness D2 of the second metal layer 52 along the light incident direction in the first region A, as shown in FIG. 3. The configuration described above, in which cracking of the second metal layer 52 when sintered is suppressed while the stress relaxation function provided by the first metal layer 51 is enhanced, can further enhance the reliability of the bonding layer 50.

The method for manufacturing the wavelength converter 40 according to the present embodiment will be subsequently described.

The method for manufacturing the wavelength converter 40 according to the present embodiment includes a first step of disposing the first metal material at the substrate 41, a second step of sintering the second metal material having a particle size smaller than that of the first metal material and disposed at the phosphor layer 42 to form the second metal layer 52, and a third step of bonding the first metal layer 51 formed by sintering the first metal material and the second metal layer 52 to each other to form the bonding layer 50.

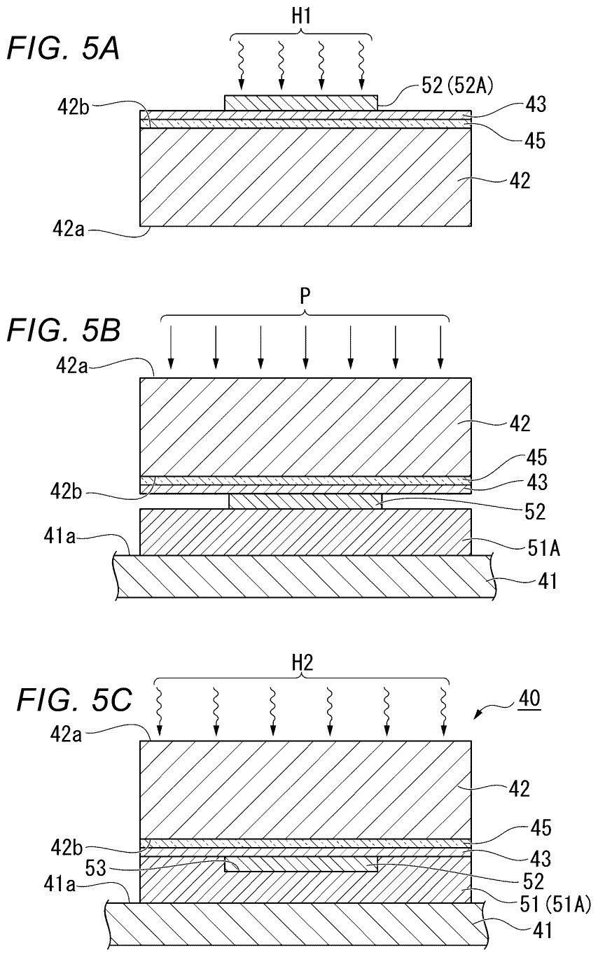

The steps will each be described below. FIGS. 5A to 5C show a part t of the step of manufacturing the wavelength converter 40.

In the first step, the first metal layer 51 is disposed at the front surface 41a of the substrate 41. A material in the form of paste containing metal particles made at least one of Ag, Au, and Cu is used as a first metal material 51A.

Subsequently, in the second step, a second metal material 52A is disposed on the second surface 42b of the phosphor layer 42, as shown in FIG. 5A. A material in the form of paste containing a metal material being metal particles made of at least one of Ag, Au, and Cu and having an average particle size smaller than that of the first metal material 51A is used as the second metal material 52A.

In the present embodiment, the phosphor layer 42 is formed, for example, by dividing a phosphor wafer with a dicing blade into individual pieces. The planarizing film 45 and the reflection member 43 have been formed in advance at the second surface 42b of the phosphor layer 42. The second metal material 52A is then sintered by applying heat H1 to the second metal material 52A to form the second metal layer 52, as shown in FIG. 5A. Since the second metal layer 52 is formed by sintering the second metal material 52A having a particle size smaller than that of the first metal material 51A as described above, the porosity of the second metal layer 52 can be made smaller than that of the first metal layer 51.

Note that the phosphor layer 42 at which the second metal layer 52 has been formed may be manufactured by sintering the second metal material 52A disposed in a predetermined region on the phosphor wafer to form the second metal layer 52, and then dividing the phosphor wafer into individual pieces each having a predetermined size.

Subsequently, in a third step, the first metal material 51A is sintered to form the first metal layer 51, and the first metal layer 51 and the second metal layer 52 are bonded to each other to form the bonding layer 50. In the present embodiment, in the third step, the first metal material 51A is sintered with the second metal layer 52 pressed against the first metal material 51A, as shown in FIG. 5B. Note in the present embodiment that the temperature at which the first metal material 51A is sintered and the temperature at which the second metal material 52A is sintered are preferably equal to each other.

Pressing the second metal layer 52 forms the recess 53 in the first metal layer 51, so that a structure in which the second metal layer 52 is disposed in the recess 53 can be formed, as shown in FIG. 5C. The wavelength converter 40 according to the present embodiment shown in FIG. 3 is thus manufactured.

In the method for manufacturing the wavelength converter 40 according to the present embodiment, the porosities of the first metal layer 51 and the second metal layer 52 are adjusted by the difference in the particle size between the first metal material 51A and the second metal material 52A, and the wavelength converter 40 may instead be manufactured by differentiating the temperatures at which the first metal material 51A and the second metal material 52A are sintered from each other to adjust the porosities of the first metal layer 51 and the second metal layer 52.

The aforementioned other method for manufacturing the wavelength converter 40 includes a first step of disposing a first metal material at the substrate 41, a second step of sintering a second metal material disposed at the phosphor layer 42 to form the second metal layer 52, and a third step of bonding the first metal layer 51 formed by sintering the first metal material at a sintering temperature lower than that for the second metal material and the second metal layer 52 to each other to form the bonding layer 50.

In the third step of the present manufacturing method, since the temperature at which the first metal material is sintered is lower than the temperature at which the second metal material is sintered, the degree of melting of the surface of each of the particles that constitute the first metal material is suppressed more than the degree of melting of the surface of each of the particles that constitute the second metal material. The particles that constitute the first metal layer therefore separate from each other by a greater amount than the particles that constitute the second metal layer. As a result, the porosity of the first metal layer can be higher than the porosity of the second metal layer. The present manufacturing method can therefore also manufacture the wavelength converter 40 including the bonding layer 50 including the first metal layer 51 and the second metal layer 52 having different porosities by adjusting the temperatures at which the first metal material and the second metal material are sintered. In the present manufacturing method, the first metal material and the second metal material preferably have the same particle size, but adjusting the sintering temperatures as appropriate allows the particle sizes of the first metal material and the second metal material to differ from each other.

As described above, the wavelength converter 40 according to the present embodiment includes the phosphor layer 42, which has the first surface 42a, on which the excitation light BLs is incident, and the second surface 42b opposite from the first surface 42a and converts the incident excitation light BLs, the substrate 41 disposed at the side facing the second surface 42b of the phosphor layer 42, and the bonding layer 50, which bonds the substrate 41 and the phosphor layer 42 to each other. The bonding layer 50 includes the first metal layer 51 facing the substrate 41 and the second metal layer 52 disposed between the first metal layer 51 and the phosphor layer 42, and the porosity of the first metal layer 51 is higher than the porosity of the second metal layer 52.

The wavelength converter 40 according to the present embodiment, which includes the bonding layer 50 having the first metal layer 51, which functions as the stress relaxation layer, and the second metal layer 52, which contributes to the improvement in the bonding strength, allows an increase in the strength of the bonding between the phosphor layer 42 and the substrate 41 with peeling or breakage of the phosphor layer 42 due to the thermal stress suppressed. Furthermore, the wavelength converter 40 according to the present embodiment, in which the phosphor layer 42 and the substrate 41 are bonded to each other via the bonding layer 50 including the second metal layer 52 having excellent thermal conductivity, allows efficient cooling of the phosphor layer 42 and hence an increase in the fluorescence conversion efficiency.

The wavelength converter 40 according to the present embodiment therefore allows improvement in both the strength at which the phosphor layer 42 is bonded and the efficiency at which the phosphor layer 42 is cooled.

The method for manufacturing the wavelength converter 40 according to the present embodiment can manufacture the wavelength converter 40 including the bonding layer 50 including the first metal layer 51 and the second metal layer 52 having different porosities by adjusting the particle sizes of the first metal material 51A and the second metal material 52A. The wavelength converter 40 that allows improvement in both the strength at which the phosphor layer 42 is bonded and the efficiency at which the phosphor layer 42 is cooled can therefore be manufactured.

In addition, the light source apparatus 2A including the wavelength converter 40, which allows an increase in the efficiency at which the phosphor layer 42 is cooled while suppressing peeling of the phosphor layer 42, can be a highly reliable light source apparatus that produces bright fluorescence YL.

In addition, the projector 1 according to the present embodiment, which includes the light source apparatus 2A described above, can form a high-luminance image.

### Second Embodiment

A wavelength converter according to a second embodiment will be subsequently described. The members common to those in the embodiment described above have the same reference characters and will not be described in detail.

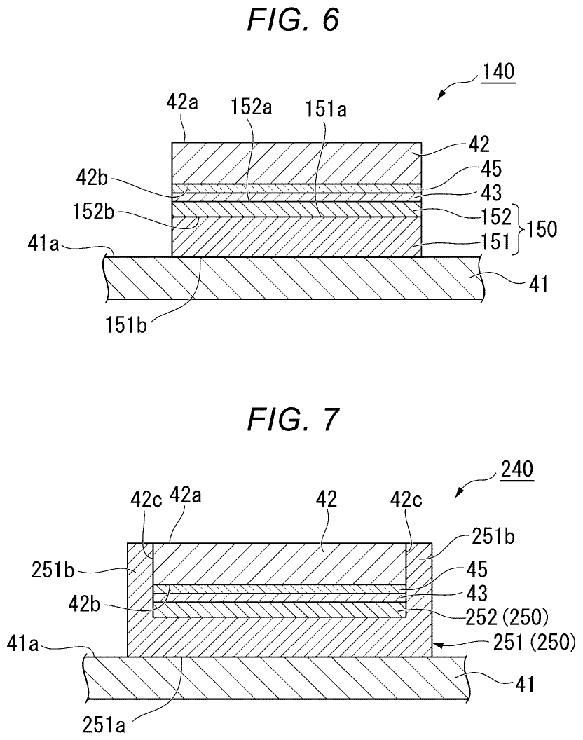

FIG. 6 is a cross-sectional view showing the configurations of key parts of a wavelength converter 140 according to the present embodiment.

The wavelength converter 140 according to the present embodiment includes the substrate 41, the phosphor layer 42, the reflection member 43, and a bonding layer 150, as shown in FIG. 6.

The bonding layer 150 in the present embodiment includes a first metal layer 151 and a second metal layer 152. In the present embodiment, the second metal layer 152 is layered on a front surface 151a of the first metal layer 151, which is a planar surface. In the plan view, the first metal layer 151 and the second metal layer 152 have the same shape as that of the phosphor layer 42. That is, in the bonding layer 150 in the present embodiment, a rear surface 152b of the second metal layer 152 and the front surface 151a of the first metal layer 151 have the same shape, and a front surface 152a of the second metal layer 152 and the second surface 42b of the phosphor layer 42 have the same shape.

The wavelength converter 140 according to the present embodiment, which includes the bonding layer 150 including the first metal layer 151, which functions as the stress relaxation layer, and the second metal layer 152, which contributes to the improvement in the bonding strength, can improve both the strength at which the phosphor layer 42 is bonded and the efficiency at which the phosphor layer 42 is cooled. In addition, since the wavelength converter 140 according to the present embodiment includes the bonding layer 150 having the structure in which the second metal layer 152 is layered on the first metal layer 151, the step of manufacturing the bonding layer 150 can be simplified as compared with the manufacturing step in the first embodiment.

### Third Embodiment

A wavelength converter according to a third embodiment will be subsequently described. The members common to those in the embodiments described above have the same reference characters and will not be described in detail.

FIG. 7 is a cross-sectional view showing the configurations of key parts of a wavelength converter 240 according to the present embodiment.

The wavelength converter 240 according to the present embodiment includes the substrate 41, the phosphor layer 42, the reflection member 43, and a bonding layer 250, as shown in FIG. 7.

The bonding layer 250 in the present embodiment includes a first metal layer 251 and a second metal layer 252. The second metal layer 252 has the same size as the phosphor layer 42, as in the wavelength converter 140 according to the second embodiment. The first metal layer 251 includes a base section 251a and a protruding section 251b.

The base section 251a is portion that faces the substrate 41 and is sandwiched between the substrate 41 and the second metal layer 252. The base section 251a extends outward beyond the second metal layer 252. The protruding section 251b is a section that protrudes toward the phosphor layer 42 from a portion of the base section 251a that protrudes outward beyond the second metal layer 252 and faces a third surface 42c of the phosphor layer 42. The third surface 42c of the phosphor layer 42 is a surface that intersects with the first surface 42a and the second surface 42b, and corresponds to the side surface of the phosphor layer 42. That is, the protruding section 251b in the present embodiment corresponds to the “facing section” in the claims.

In the present embodiment, a part of the protruding section 251b of the first metal layer 251 is in contact with the third surface 42c, which is the side surface of the phosphor layer 42.

The wavelength converter 240 according to the present embodiment, which includes the bonding layer 250 including the first metal layer 251, which functions as the stress relaxation layer, and the second metal layer 252, which contributes to the improvement in the bonding strength, can improve both the strength at which the phosphor layer 42 is bonded and the efficiency at which the phosphor layer 42 is cooled. In addition, the configuration in which the third surface 42c, which is the side surface of the phosphor layer 42, is covered with the protruding section 251b of the first metal layer 251, can suppress chipping or breakage of the third surface 42c, which is the side surface of the phosphor layer 42, even when an external force is applied for some reason. The durability of the phosphor layer 42 can therefore be enhanced. Since a part of the protruding section 251b is in contact with the third surface 42c of the phosphor layer 42, the heat of the phosphor layer 42 can be dissipated toward the first metal layer 251 via the protruding section 251b. The efficiency at which the phosphor layer 42 is cooled can therefore be further increased.

Note that the technical scope of the present disclosure is not limited to the embodiments described above, and a variety of changes can be made thereto without departing from the intent of the present disclosure.

In the wavelength converter 40 according to the first embodiment, the first metal layer 51 is disposed so as to surround the entire circumference of the second metal layer 52 in the plan view, but the positional relationship between the second metal layer 52 and the first metal layer 51 is not limited thereto. For example, a part of the side surface of the first metal layer 51 may be exposed beyond the second metal layer 52 in the plan view. That is, in the plan view, a part of the side surface of the first metal layer 51 may be flush with the side surface of the second metal layer 52, or a part of the side surface of the first metal layer 51 may protrude from the side surface of the second metal layer 52.

In the wavelength converter 40 according to the first embodiment, the bonding layer 50 is sized so as to cover the entire second surface 42b of the phosphor layer 42, so that the bonding layer 50 is bonded to the circumferential edge 42b1 of the second surface 42b, but the bonding layer 50 may not cover a part of the second surface 42b of the phosphor layer 42. That is, the bonding layer 50 may not be bonded to a part of the circumferential edge 42b1 of the second surface 42b.

In the first and second embodiments, the outer circumferential sides of the bonding layers 50 and 150 coincide with the outer circumferential side of the phosphor layer 42 in the plan view, but at least a part of the outer circumferential sides of the bonding layers 50 and 150 may extend off the outer circumferential side of the phosphor layer 42.

The wavelength converter according to the present disclosure is not limited to an immobile wavelength converter, and the present disclosure is applicable, for example, to a rotary wavelength converter in which a circular substrate rotates.

In the first embodiment, the reflection member and the bonding layer are provided, but when the bonding layer has sufficient reflection characteristics, the reflection member may be omitted.

In the first embodiment, the bonding layer includes the first metal layer and the second metal layer, but the number of layers is not limited thereto. For example, the bonding layer may include three or more layers. The term “layer” is not limited to a layer having a clear boundary between a substance and a substance, and a case where the porosity gradually changes from the substrate toward the phosphor layer can be interpreted as multiple metal layers having multiple different porosities.

The aforementioned embodiments have been described with reference to the case where the light source apparatus according to the present disclosure is incorporated in a projector, but not necessarily. The light source apparatus according to the present disclosure may be incorporated in a lighting apparatus, a headlight of an automobile, and other apparatuses.

The present disclosure will be summarized below as additional remarks.

### Additional Remark 1

A wavelength converter including:
a wavelength converting layer having a first surface on which light is incident and a second surface opposite from the first surface and configured to convert the incident light;
a substrate disposed at a side facing the second surface of the wavelength converting layer; and
a bonding layer configured to bond the substrate and the wavelength converting layer to each other,
wherein the bonding layer includes a first metal layer facing the substrate and a second metal layer disposed between the first metal layer and the wavelength converting layer, and
a porosity of the first metal layer is higher than a porosity of the second metal layer.

The thus configured wavelength converter, which includes the bonding layer having the first metal layer, which has a high porosity and functions as the stress relaxation layer, and the second metal layer, which has a low porosity and contributes to the improvement in the bonding strength, allows an increase in the strength of the bonding between the wavelength converting layer and the substrate while suppressing peeling or breakage of the wavelength converting layer due to thermal stress. Furthermore, since the wavelength converting layer and the substrate are bonded to each other via the second metal layer having excellent thermal conductivity, the wavelength converting layer can be efficiently cooled, so that the wavelength conversion efficiency can be increased.

The configuration described above therefore allows improvement in both the strength at which the wavelength converting layer is bonded and the efficiency at which the wavelength converting layer is cooled.

### Additional Remark 2

The wavelength converter according to the additional remark 1, wherein
the second metal layer is disposed in correspondence with a light incident region in the wavelength converting layer on which the light is incident.

According to the configuration described above, the second metal layer having excellent thermal conductivity is disposed in the region corresponding to the highest-temperature light incident region of the wavelength converting layer, so that the wavelength converting layer can be efficiently cooled.

### Additional Remark 3

The wavelength converter according to the additional remark 2, wherein the first metal layer is disposed so as to surround a circumference of the second metal layer.

According to the configuration described above, since the first metal layer is disposed so as to surround the circumference of the second metal layer within the bonding surface of the bonding layer, the first metal layer can provide the stress relaxation function in a balanced manner within the bonding surface. The effect of suppressing peeling or breakage of the wavelength converting layer can therefore be further enhanced.

### Additional Remark 4

The wavelength converter according to any one of the additional remarks 1 to 3, wherein
the second metal layer is disposed in a recess provided in the first metal layer, and
the first metal layer and the second metal layer are in contact with the wavelength converting layer.

According to the configuration described above, since the first metal layer and the second metal layer are in contact with the wavelength converting layer, the stress relaxation function of the first metal layer and the cooling efficiency improvement function of the second metal layer can be efficiently provided within the bonding surface.

### Additional Remark 5

The wavelength converter according to any one of the additional remarks 1 to 4, wherein
the porosity of the first metal layer is higher than or equal to 30% but lower than 40%, and
the porosity of the second metal layer is higher than or equal to 10% but lower than 30%.

The configuration described above can realize a bonding layer in which the porosity of the first metal layer is higher than the porosity of the second metal layer.

### Additional Remark 6

The wavelength converter according to any one of the additional remarks 1 to 5, wherein
the first metal layer contains at least one of Ag, Au, and Cu, and
the second metal layer contains at least one of Ag, Au, and Cu.

The configuration described above can realize a bonding layer including a first metal layer and a second metal layer having different porosities.

### Additional Remark 7

The wavelength converter according to any one of the additional remarks 1 to 6, wherein
the bonding layer is bonded to a circumferential edge of the second surface of the wavelength converting layer.

The configuration described above can suppress occurrence of failure such as peeling of the bonding layer or chipping or cracking of the circumferential edge. The thus configured bonding layer can further enhance the reliability of the bonding between the substrate and the wavelength converting layer.

### Additional Remark 8

The wavelength converter according to any one of the additional remarks 1 to 7, wherein
the bonding layer has a first region in which the first metal layer and the second metal layer overlap with each other in a light incident direction in which the light is incident on the wavelength converting layer, and
a thickness of the first metal layer along the light incident direction in the first region is greater than a thickness of the second metal layer along the light incident direction in the first region.

The configuration described above, in which cracking of the second metal layer when sintered is suppressed while the stress relaxation function provided by the first metal layer is enhanced, can further enhance the reliability of the bonding layer.

### Additional Remark 9

The wavelength converter according to any one of the additional remarks 1 to 8, wherein
the first metal layer includes a facing section facing a third surface of the wavelength converting layer that intersects with the first and second surfaces, and
a part of the facing section of the first metal layer is in contact with the third surface of the wavelength converting layer.

The configuration described above, in which the third surface of the wavelength converting layer is covered with the facing section of the first metal layer, can suppress chipping or breakage of the third surface of the wavelength converting layer even when an external force is applied for some reason. The durability of the wavelength converting layer can therefore be enhanced. In addition, since a part of the facing section is in contact with the third surface of the wavelength converting layer, heat of the wavelength converting layer can be dissipated toward the first metal layer via the facing section. The efficiency at which the wavelength converting layer is cooled can therefore be further increased.

### Additional Remark 10

The wavelength converter according to any one of the additional remarks 1 to 3, wherein
the wavelength converting layer includes a planarizing film configured to planarize the second surface.

According to the configuration described above, the planarizing film can further improve the degree of evenness of the surface of the wavelength converting layer. The adhesion between the wavelength converting layer and the bonding layer is therefore enhanced, so that the bonding strength produced by the bonding layer can be further improved.

### Additional Remark 11

A light source apparatus including:
the wavelength converter according to any one of the additional remarks 1 to 10; and
a light source configured to output the light to the wavelength converter.

The thus configured light source apparatus, which allows an increase in the efficiency at which the wavelength converting layer is cooled while suppressing peeling of the wavelength converting layer, can be a highly reliable light source apparatus that generates bright light.

### Additional Remark 12

A projector including:
the light source apparatus according to the additional remark 11;
a light modulator configured to modulate light output from the light source apparatus based on image information, and
a projection system configured to project light output from the light modulator.

The thus configured projector, which includes the light source apparatus described above, can form a high-luminance image.

### Additional Remark 13

A method for manufacturing a wavelength converter including a wavelength converting layer, a substrate, and a bonding layer configured to bond the substrate and the wavelength converting layer to each other, the bonding layer including a first metal layer facing the substrate and a second metal layer having a porosity higher than a porosity of the first metal layer and disposed between the first metal layer and the wavelength converting layer, the method including:
a first step of disposing a first metal material at the substrate;
a second step of sintering a second metal material disposed at the wavelength converting layer and having a particle size smaller than a particle size of the first metal material to form the second metal layer; and
a third step of bonding the first metal layer formed by sintering the first metal material and the second metal layer to each other to form the bonding layer.

The thus configured method for manufacturing a wavelength converter can manufacture a wavelength converter including the bonding layer including the first and second metal layers having different porosities by adjusting the particle sizes of the first and second metal materials. A wavelength converter that allows improvement in both the strength at which the wavelength converting layer is bonded and the efficiency at which the wavelength converting layer is cooled can therefore be provided.

### Additional Remark 14

A method for manufacturing a wavelength converter including a wavelength converting layer, a substrate, and a bonding layer configured to bond the substrate and the wavelength converting layer to each other, the bonding layer including a first metal layer facing the substrate and a second metal layer having a porosity higher than a porosity of the first metal layer and disposed between the first metal layer and the wavelength converting layer, the method including:
a first step of disposing a first metal material at the substrate;
a second step of sintering a second metal material disposed at the wavelength converting layer to form the second metal layer; and
a third step of bonding the second metal layer to the first metal layer formed by sintering the first metal material at a sintering temperature lower than a temperature at which the second metal material is sintered to form the bonding layer.

The thus configured method for manufacturing a wavelength converter can manufacture a wavelength converter including a bonding layer including the first and second metal layers having different porosities by adjusting the temperatures at which the first and second metal materials are sintered. A wavelength converter that allows improvement in both the strength at which the wavelength converting layer is bonded and the efficiency at which the wavelength converting layer is cooled can therefore be provided.

### Additional Remark 15

The method for manufacturing a wavelength converter according to the additional remark 13 or 14, wherein
in the first step, metal particles containing at least one of Ag, Au, and Cu are used as the first metal material, and
in the second step, metal particles containing at least one of Ag, Au, and Cu are used as the second metal material.

The configuration described above allows manufacture of the bonding layer including the first and second metal layers having different porosities through sintering the first and second metal materials.

### Additional Remark 16

The method for manufacturing a wavelength converter according to any one of the additional remarks 13 to 15, wherein
in the third step, the first metal material is sintered with the second metal layer pressed against the first metal material.

The configuration described above allows manufacture of a structure in which the second metal layer is disposed in a recess formed in the first metal layer.

What is claimed is:

1. A wavelength converter comprising:
a wavelength converting layer having a first surface on which light is incident and a second surface opposite from the first surface and configured to convert the incident light;
a substrate disposed at a side facing the second surface of the wavelength converting layer; and
a bonding layer configured to bond the substrate and the wavelength converting layer to each other,
wherein the bonding layer includes a first metal layer facing the substrate and a second metal layer disposed between the first metal layer and the wavelength converting layer, and
a porosity of the first metal layer is higher than a porosity of the second metal layer.

2. The wavelength converter according to claim 1, wherein
the second metal layer is disposed in correspondence with a light incident region in the wavelength converting layer on which the light is incident.

3. The wavelength converter according to claim 2, wherein
the first metal layer is disposed so as to surround a circumference of the second metal layer.

4. The wavelength converter according to claim 1, wherein
the second metal layer is disposed in a recess provided in the first metal layer, and
the first metal layer and the second metal layer are in contact with the wavelength converting layer.

5. The wavelength converter according to claim 1, wherein
the porosity of the first metal layer is higher than or equal to 30% but lower than 40%, and
the porosity of the second metal layer is higher than or equal to 10% but lower than 30%.

6. The wavelength converter according to claim 1, wherein
the first metal layer contains at least one of Ag, Au, and Cu, and
the second metal layer contains at least one of Ag, Au, and Cu.

7. The wavelength converter according to claim 1, wherein
the bonding layer is bonded to a circumferential edge of the second surface of the wavelength converting layer.

8. The wavelength converter according to claim 1, wherein
the bonding layer has a first region in which the first metal layer and the second metal layer overlap with each other in a light incident direction in which the light is incident on the wavelength converting layer, and
a thickness of the first metal layer along the light incident direction in the first region is greater than a thickness of the second metal layer along the light incident direction in the first region.

9. The wavelength converter according to claim 1, wherein
the first metal layer includes a facing section facing a third surface of the wavelength converting layer that intersects with the first and second surfaces, and
a part of the facing section of the first metal layer is in contact with the third surface of the wavelength converting layer.

10. The wavelength converter according to claim 1, wherein
the wavelength converting layer includes a planarizing film configured to planarize the second surface.

11. A light source apparatus comprising:
the wavelength converter according to claim 1; and
a light source configured to output the light to the wavelength converter.

12. A projector comprising:
the light source apparatus according to claim 11;
a light modulator configured to modulate light output from the light source apparatus based on image information, and
a projection system configured to project light output from the light modulator.

13. A method for manufacturing a wavelength converter including a wavelength converting layer, a substrate, and a bonding layer configured to bond the substrate and the wavelength converting layer to each other, the bonding layer including a first metal layer facing the substrate and a second metal layer having a porosity higher than a porosity of the first metal layer and disposed between the first metal layer and the wavelength converting layer, the method comprising:
a first step of disposing a first metal material at the substrate;
a second step of sintering a second metal material disposed at the wavelength converting layer and having a particle size smaller than a particle size of the first metal material to form the second metal layer; and
a third step of bonding the first metal layer formed by sintering the first metal material and the second metal layer to each other to form the bonding layer.

14. A method for manufacturing a wavelength converter including a wavelength converting layer, a substrate, and a bonding layer configured to bond the substrate and the wavelength converting layer to each other, the bonding layer including a first metal layer facing the substrate and a second metal layer having a porosity higher than a porosity of the first metal layer and disposed between the first metal layer and the wavelength converting layer, the method comprising:
a first step of disposing a first metal material at the substrate;
a second step of sintering a second metal material disposed at the wavelength converting layer to form the second metal layer; and
a third step of bonding the second metal layer to the first metal layer formed by sintering the first metal material at a sintering temperature lower than a temperature at which the second metal material is sintered to form the bonding layer.

15. The method for manufacturing a wavelength converter according to claim 13, wherein
in the first step, metal particles containing at least one of Ag, Au, and Cu are used as the first metal material, and
in the second step, metal particles containing at least one of Ag, Au, and Cu are used as the second metal material.

16. The method for manufacturing a wavelength converter according to claim 13, wherein
in the third step, the first metal material is sintered with the second metal layer pressed against the first metal material.
